(19) United States
(12) Patent Application Publication
(10) Pub. No.: US 2023/0403291 A1
(43) Pub. Date: Dec. 14, 2023

(54) FRAMEWORK FOR ANOMALY DETECTION IN A CLOUD ENVIRONMENT

(71) Applicant: Oracle International Corporation, Redwood Shores, CA (US)

(72) Inventors: Olgierd Stanislaw Pieczul, Dublin (IE); Tasneem Singh, Seattle, WA (US); Deepanjan Pal, Kolkata (IN)

(73) Assignee: Oracle International Corporation, Redwood Shores, CA (US)

(21) Appl. No.: 17/836,712

(22) Filed: Jun. 9, 2022

(51) Int. Cl. H04L 9/40

(52) U.S. Cl. CPC H04L 63/1425

(57) ABSTRACT

The present disclosure describes an anomaly detection system that generates a resource group including a plurality of resources of a monitored environment based on a grouping property. The values of the grouping property associated with the plurality of resources satisfy a first condition. A first invariance identifying property is selected from a set of invariance identifying properties. It is determined whether values of the first invariance identifying property associated with the plurality of resources satisfy a second condition. Responsive to a successful determination, a first invariant is incorporated in a baseline, wherein the first invariant is defined by the grouping property and the first invariance identifying property. The baseline is used by the anomaly detection system for performing anomaly detection of the monitored environment.

### FIELD

The present disclosure relates generally to a framework for performing anomaly detection in a cloud environment.

### BACKGROUND

Intrusion detection is a large and increasingly growing field of computer security. Over the years, a number of techniques have been developed that focus on different types of intrusions, using a variety of mechanisms. This has led to a number of attempts to provide a systematic classification of intrusion detection systems. The most common way to characterize intrusion detection systems is based on a detection mechanism. For instance, one type of intrusion detection system is referred to as a ‘knowledge-based’ or ‘signature’ detection system that focuses on identifying attacks based on knowledge accumulated from known incidents. Another type of intrusion detection system is referred to as ‘behavior-based’ or ‘anomaly’ detection systems. The goal in such intrusion detection systems is to identify system behavior that is unusual when compared with activity of the system observed during a known normal state.

The key advantage of using knowledge-based systems is their low false-positive rate and high performance. This is because such systems typically perform very simple verification using precise criteria defining known attacks. The main challenge faced by knowledge-based systems is the inability to detect previously unknown or unexpected misuse scenarios. As new attack techniques or mutations of existing ones are discovered, the set of signatures becomes obsolete and the protection weakens. New attacks need to be continuously recorded and rule sets kept up to date. Also, the modern advanced malware uses polymorphism to modify its behavior making the detection by the knowledge-based systems more difficult.

Anomaly detection is based on the assumption that a deviation from system's normal behavior may represent an intrusion. The key benefit of this approach is an ability to detect unknown or unexpected attacks. Contrary to knowledge-based systems, prior expert knowledge such as definitions of attacks does not need to be specified. However, in practice, behavior-based mechanisms include a knowledge-based component, which may include specification of what characteristic to monitor, what kind of deviation should be classified as an anomaly, and so forth.

Anomaly detection systems are a valuable component of intrusion detection. However, they depend on the ability to identify the ‘normal’ state of a system that can be used as a baseline to identify anomalies. Thus, the method of establishing the normal (i.e., the baseline) is key to a successful deployment of the anomaly detection system. Such a task of identifying the baseline is further complicated in a cloud environment, where tasks such as resource provisioning, user's ability to build workloads in the cloud environment as well as to react to customer demands, etc., occur at a fast rate. Embodiments described herein address these and other problems, individually and collectively.

### SUMMARY

The present disclosure relates to a framework to perform anomaly detection in a cloud environment by identifying correlations between properties of cloud resources and using the identified correlations as security indicators to detect occurrence of an anomaly in the cloud environment. Various embodiments are described herein, including methods, systems, non-transitory computer-readable storage media storing programs, code, or instructions executable by one or more processors, and the like.

An aspect of the present disclosure provides for a method comprising: generating a resource group including a plurality of resources of a monitored environment based on a grouping property, wherein values of the grouping property associated with the plurality of resources satisfy a first condition; selecting a first invariance identifying property from a set of invariance identifying properties; determining whether values of the first invariance identifying property associated with the plurality of resources satisfy a second condition; responsive to a successful determination, incorporating a first invariant in a baseline, wherein the first invariant is defined by the grouping property and the first invariance identifying property; and using the baseline for performing anomaly detection of the monitored environment.

Another aspect of the present disclosure provides for a computing device comprising: a processor; and a memory including instructions that, when executed with the processor, cause the computing device to, at least: generate a resource group including a plurality of resources of a monitored environment based on a grouping property, wherein values of the grouping property associated with the plurality of resources satisfy a first condition; select a first invariance identifying property from a set of invariance identifying properties; determine whether values of the first invariance identifying property associated with the plurality of resources satisfy a second condition; responsive to a successful determination, incorporate a first invariant in a baseline, wherein the first invariant is defined by the grouping property and the first invariance identifying property; and use the baseline for performing anomaly detection of the monitored environment.

One aspect of the present disclosure provides for a non-transitory computer readable medium storing specific computer-executable instructions that, when executed by a processor, cause a computer system to perform operations comprising: identifying a set of resources in an environment to be monitored; generating one or more resource groups, each resource group including a plurality of resources and being generated based on a grouping property, wherein values of the grouping property associated with the plurality of resources included in the resource group satisfy a first condition; identifying, for each of the one or more resource groups, an invariance identifying property; determining, for each of the one or more resource groups, whether values of the invariance identifying property associated with the plurality of resources included in the resource group satisfy a second condition; responsive to a successful determination, incorporating an invariant in a baseline, wherein the invariant is defined by the grouping property and the invariance identifying property; and using the baseline for performing anomaly detection of the environment to be monitored.

The foregoing, together with other features and embodiments will become more apparent upon referring to the following specification, claims, and accompanying drawings.

### BRIEF DESCRIPTION OF THE DRAWINGS

The specification makes reference to the following appended figures, in which use of like reference numerals in different figures is intended to illustrate like or analogous components.

FIG. 1 is a simplified diagram of an anomaly detection system according to certain embodiments.

FIG. 2 is a flowchart illustrating a high-level process performed by the anomaly detection system according to certain embodiments.

FIG. 3 is a system diagram of a baseline generator included in the anomaly detection system according to certain embodiments.

FIGS. 4A and 4B depict a flowchart illustrating an example process performed by the baseline generator according to certain embodiments.

FIG. 5 is a schematic illustrating correlations between properties of cloud resources according to certain embodiments.

FIG. 6 depicts an exemplary table illustrating resources included in a cloud environment and corresponding properties of the resources according to certain embodiments.

FIGS. 7A and 7B depict a flowchart illustrating an example process of performing anomaly detection, according to certain embodiments.

FIG. 8 is a block diagram illustrating one pattern for implementing a cloud infrastructure as a service system, according to at least one embodiment.

FIG. 9 is a block diagram illustrating another pattern for implementing a cloud infrastructure as a service system, according to at least one embodiment.

FIG. 10 is a block diagram illustrating another pattern for implementing a cloud infrastructure as a service system, according to at least one embodiment.

FIG. 11 is a block diagram illustrating another pattern for implementing a cloud infrastructure as a service system, according to at least one embodiment.

FIG. 12 is a block diagram illustrating an example computer system, according to at least one embodiment.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

Building secure applications in a cloud environment challenges traditional security practice. Specifically, shared responsibility model and dynamic nature of the cloud infrastructure make traditional modeling of threats difficult. As cloud infrastructure evolves, it provides new and sometimes unexpected features. While traditional cloud environments provide mechanisms for some security problems, they may also introduce new security problems. Moreover, significant changes to the infrastructure itself may emerge from trivial changes in configuration. For example, a system administrator building a system in the cloud may deal with virtual networks provided by the cloud. Even if experienced with traditional networking, or cloud networks of other vendors, system administrator(s) may not fully comprehend all the aspects of the specific service(s) they utilize. For instance, ability to declare a specific subnet of the network as ‘public’ and therefore allowing devices in the network to use public addresses may be counter-intuitive or unexpected. Traditionally, exposing network devices to public addresses may be a major configuration task requiring network redesign.

Often, the aspects of security could be outsourced or delegated to a cloud provider. For example, rather than building their own key management solution, a customer may use one offered by cloud vendors. While this is generally beneficial to the cloud user and reduces their cost of managing security, it introduces new problems. Security mechanisms provided by the cloud provider need to be properly enabled, configured, and integrated with customer workloads that are being executed in the cloud environment. In one scenario, customers may take advantage of Platform-as-a-service (PaaS) components offered by the cloud provider. Databases, middleware and streaming services are costly to manage to achieve high performance and availability and choosing managed services will typically be attractive. However, just as with security-specific solutions, usage of cloud vendor-managed systems introduces potential threats related to its proper usage, configuration and integration with other systems.

Anomaly detection is one way of identifying security problems in a system. Broadly speaking, anomaly detection includes two core tasks. A first task is to identify a baseline i.e., a normal state of the system. It is appreciated that the normal state does not have to be prescribed by humans e.g., system administrators, but could rather be learned from the system through observation. The second task is to identify deviations from the normal state. Using anomaly detection could be particularly attractive in the cloud environment with its numerous resources, both in terms of type and quantity. Rather than manually prescribing criteria of secure state of the system, one could learn the state automatically.

However, the process of anomaly detection can be challenging. The process of provisioning cloud infrastructure is easy and fast. As such, the cloud user's ability to build workloads as well as to react to customer demands occurs at a fast rate. Cloud users may deploy applications in chosen geolocations, connect elements of their system or fundamentally change network topology through programmatic interfaces provided by cloud vendor, etc. Such rapid changes in the cloud environment challenges traditional security processes as well as continuously changes the baseline. The changes to an infrastructure in a traditional environment are typically slow and require planning and testing. As such, any deviation from the standard (i.e., baseline) is easy to observe in traditional environments. However, in the cloud environment, as such changes occur at a fast rate and are often reactive to user demand or other changing circumstances, anomaly detection in the cloud environment is challenging. Embodiments described herein address these and other problems, individually and collectively. Specifically, embodiments of the present disclosure provide for a framework to perform anomaly detection in a cloud environment by identifying correlations between properties of cloud resources and using them as security indicators to detect occurrence of an anomaly.

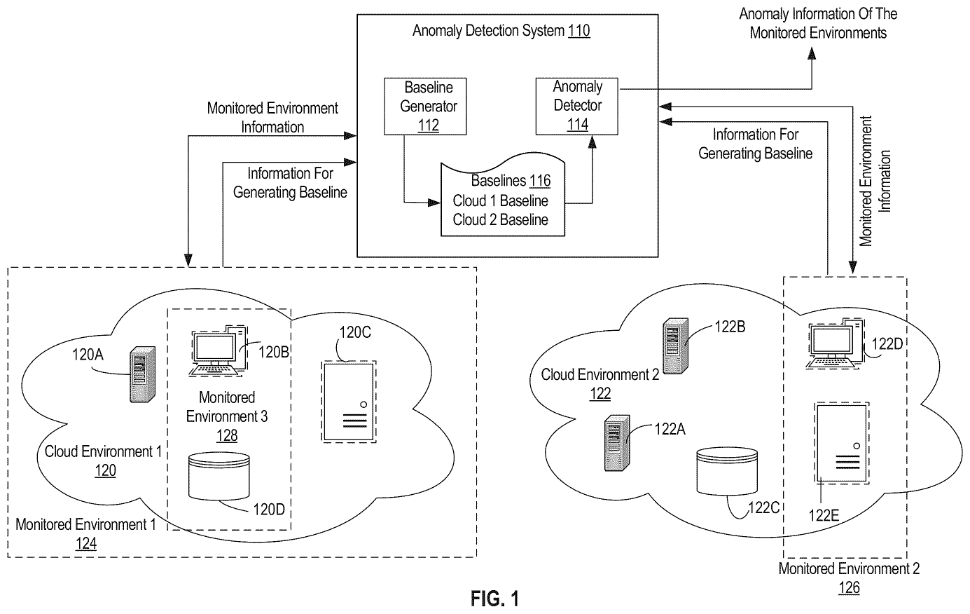

Turning to FIG. 1, there is depicted a simplified diagram of an anomaly detection system according to certain embodiments. The anomaly detection system 110 of FIG. 1 includes a baseline generator 112, and an anomaly detector 114. The anomaly detection system 110 is configured to detect anomalies in different cloud environments. For instance, as shown in FIG. 1, a first cloud environment 120 includes a plurality of resources 120A, 120B, 120C and 120D and a second cloud environment 122 includes resources labeled 122A to 122E.

By some embodiments, the anomaly detection system 110 is programmed to monitor the entire cloud environment 120 for detecting anomalies. This is represented by the dotted box 124 corresponding to an environment that is to be monitored by the anomaly detection system 110. In other words, the anomaly detection system 110 monitors resources included in the entire cloud environment 120 for anomaly detection purposes. In some embodiments, the anomaly detection system 110 can be programmed to monitor a portion of a cloud environment for anomaly detection purposes. For instance, as shown in FIG. 1, with respect to the second cloud environment 122, the anomaly detection system 110 is programmed to monitor a portion of the resources (i.e., resources 122D and 122E) for anomaly detection purposes. The portion of the second cloud environment 122 that is monitored by the anomaly detection system 110 is represented by the dotted box 126 labeled as monitored environment 2. Similarly, the anomaly detection system 110 may be configured to monitor a portion of the first cloud environment 120 that is represented by the dotted box 128 labeled as monitored environment 3.

For each monitored environment (e.g., the first monitored environment 124, and the second monitored environment 126), the baseline generator 112 of the anomaly detection system 110 receives information pertaining to the resources included in the monitored environment. Such information may correspond to a number (and type) of resources included in the respective environments, a state of the properties of the resources included in the environment, etc. Such information obtained from the respective environments is utilized by the baseline generator 112 to generate a baseline (for anomaly detection) for each environment. The baselines generated for the respective monitored environments are stored locally in the anomaly detection system 110 as baselines 116. For instance, as shown in FIG. 1, the baseline generator 112 generates a baseline for each of the environments that is to be monitored for performing anomaly detection. In some embodiments, the baseline generator 112 obtains, once, the information for generating baselines from the respective environments that are to be monitored, and generates and stores the baselines 116 in the anomaly detection system 110.

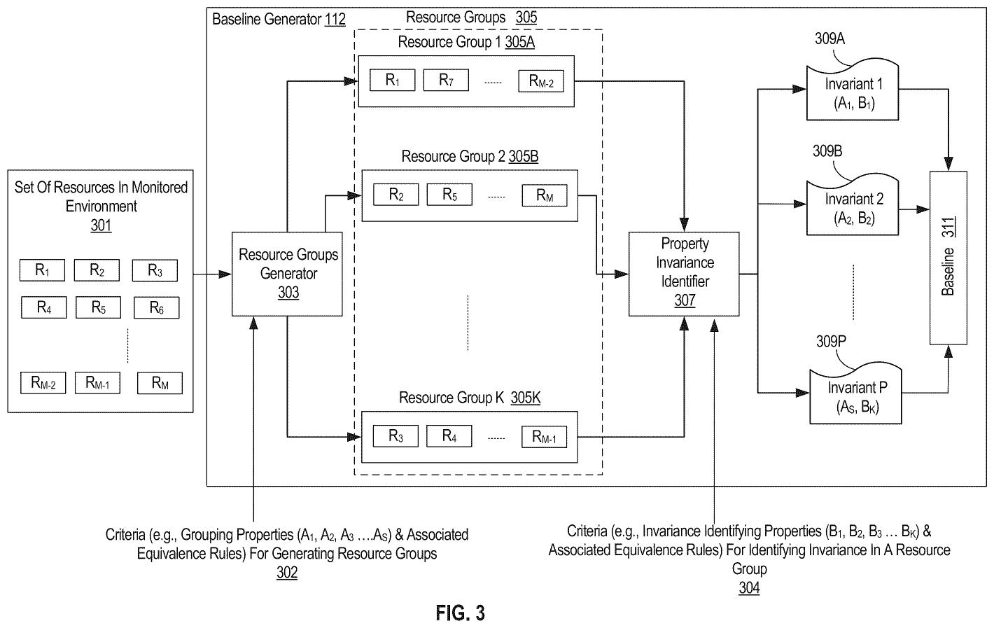

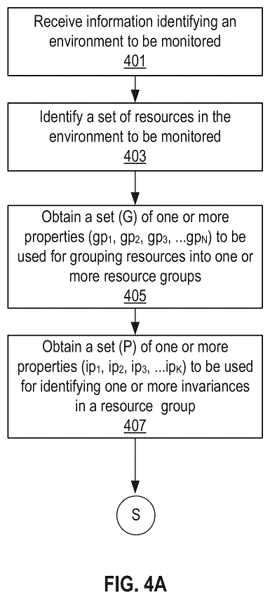

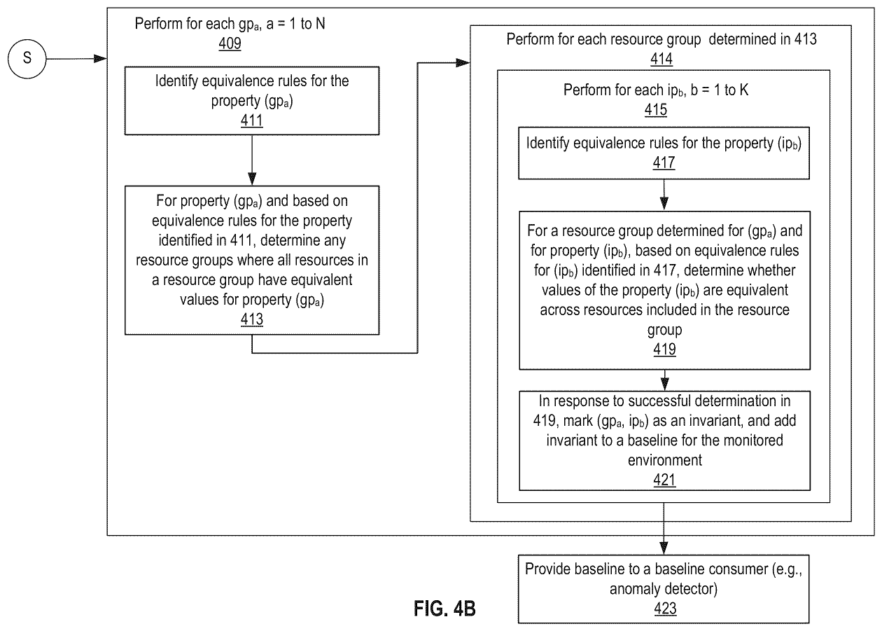

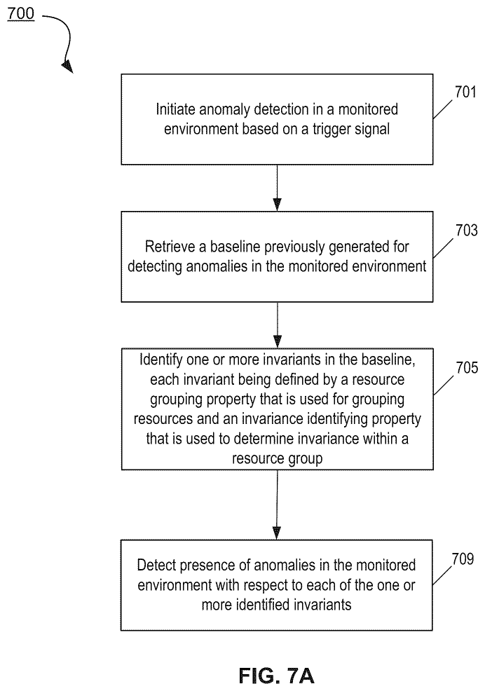

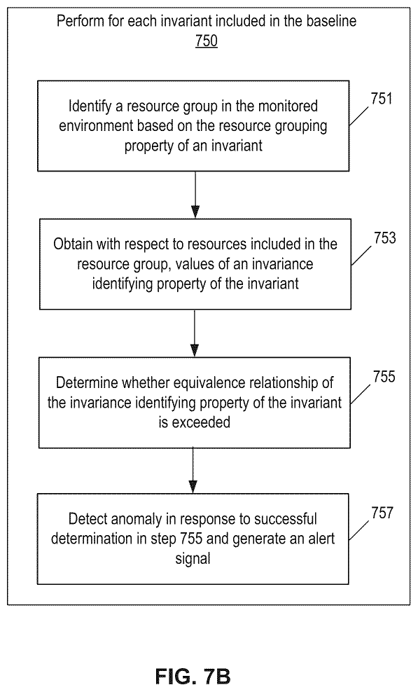

Further, the baselines 116 are utilized by the anomaly detector 114 of the anomaly detection system 110 for performing anomaly detection in the respective monitored environments. Specifically, in one implementation, the anomaly detector 114 obtains, in real time, information pertaining to the resources included in the environments (i.e., monitored environment information such as a number (and type) of resources included in the respective environments, a state of the properties of the resources included in the environment, etc.), and performs anomaly detection in the respective environments based on the obtained information and the corresponding baselines previously generated for the respective environment. The anomaly detector 114 can be configured to output a report including the detected anomalies in the respective environments. Details pertaining to the baseline generator and the generation of a baseline for an environment to be monitored are described here with reference to FIG. 3 and FIGS. 4A-4B. Details pertaining to the operations of the anomaly detector 114 are described here with reference to FIGS. 7A-7B.

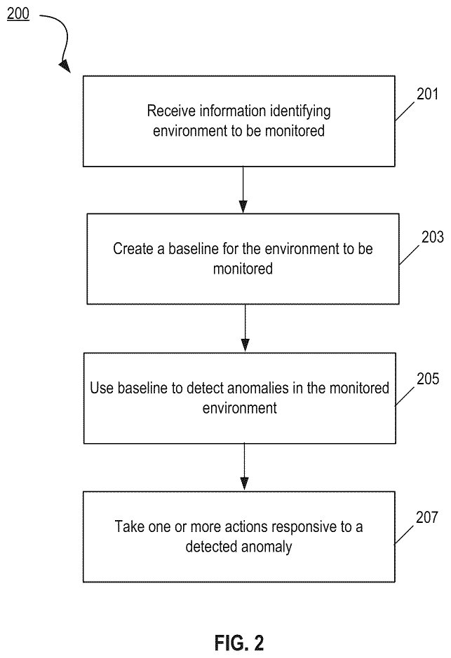

FIG. 2 is a flowchart illustrating a high-level process 200 performed by the anomaly detection system according to certain embodiments. The processing depicted in FIG. 2 may be implemented in software (e.g., code, instructions, program) executed by one or more processing units (e.g., processors, cores) of the respective systems, using hardware or combinations thereof. The software may be stored on a non-transitory storage medium (e.g., on a memory device). The method presented in FIG. 2 and described below is intended to be illustrative and non-limiting. Although FIG. 2 depicts the various processing steps occurring in a particular sequence or order, this is not intended to be limiting. In certain alternative embodiments, the processing may be performed in some different order or some steps may also be performed in parallel. In certain embodiments, the processing depicted in FIG. 2 may be performed by the anomaly detection system 110 of FIG. 1.

The process commences in step 201, where the anomaly detection system receives information identifying an environment that is to be monitored. An example of the environment to be monitored may correspond to one of the monitored environments 124, 126, or 128 of FIG. 1. Information pertaining to the environment to be monitored may correspond to an identifier associated with the environment or metadata that identifies a particular environment that is to be monitored and/or other contexual information related to the environment.

Upon receiving the information pertaining to the environment that is to be monitored, the anomaly detection system in step 203, creates a baseline for the environment. Specifically, in some embodiments, the baseline generator 112 of the anomaly detection system 110 analyzes information pertaining to, for example, a number and type of resources included in the environment a state of the resources (e.g., values of properties of the resources). Based on such information, the baseline generator 112 generates a baseline for the environment.

Upon generating the baseline for the particular environment, in step 205, the anomaly detector of the anomaly detection system 110 utilizes the baseline (generated in step 203) to detect anomalies in the particular environment. Further, in step 207, the anomaly detection system takes one or more actions responsive to detecting an anomaly in the monitored environment. For instance, the anomaly detection system may transmit a message indicative of the detected anomaly (i.e., identifying resources of the environment that caused the anomaly) to an authorized personnel e.g., system administrator of the cloud environment. In what follows, there is provided details of the generation of the baseline for a particular environment with reference to FIG. 3 and FIGS. 4A-4B, and details pertaining to performing anomaly detection with reference to FIGS. 7A-7B.

FIG. 3 is a system diagram of a baseline generator 112 included in the anomaly detection system according to certain embodiments. The baseline generator 112 includes a resource groups generator 303 and a property invariance identifier 307. The resource groups generator 303 obtains a set of resources 301 included in an environment that is to be monitored. It is appreciated that resources included in the environment may correspond to resources such as subnets, compute instances, load balancers, networks, secrets (i.e., keys, certificates). Based on the obtained resources 301, the resource groups generator 303 generates resource groups 305 in accordance with first input criteria 302. The resource groups 305 include resource group 1 305A, resource group 2 305B . . . , and resource group K 305K. By some embodiments, the first input criteria 302 includes a set of properties of resources (referred to herein as ‘grouping properties’) that can be utilized by the resource groups generator 303 to form/generate the one or more resource groups.

It is appreciated that the resource groups generator 303 may utilize one of many techniques to group the resources 301. For instance, the resource groups generator 303 may implement a natural grouping method, an explicit grouping method, and/or a property based grouping method to form the one or more resource groups (e.g., resource group 1 305A, resource group 2 305B) from the set of resources 301. The natural grouping method reflects traditional ways of organizing resources. For example, resources can be grouped together based on whether the resources are located in the same network, resources located in the same rack, or in the same building, geolocation, and so forth. In some embodiments, explicit grouping methods may be utilized to group the set of resources 301. For example, in certain scenarios, cloud vendors may introduce their own additional constructs (e.g., compartments) that are meant specifically for grouping resources. Compartments are a way of explicitly grouping resources rather than just relying on natural grouping schemes. Grouping in general, helps provide a high level view of the shared common properties between the cloud resources and a compartment is a collection of such related resources. A compartment can be a collection of cloud networks, compute instances, block volumes, etc., where the access to these resources can be managed through policy enforcement. Furthermore, it is noted that each compartment works in complete isolation and is independent of other compartments.

In some embodiments, besides natural grouping and explicit grouping methods, the resource groups generator 303 may implement a property based grouping mechanism. In such a grouping method, resources may be grouped based on a specific property or set of properties that are shared by the resources. For instance, resources of a given type (e.g., compute instances) may be grouped together, all resources that share some specific property (e.g., all Linux machines, machines running a same version of an operating system) may be grouped together. According to some embodiments, resources may be grouped by specifying a property (or a particular set of properties) that should be considered in grouping the resources, as well as an equivalence rule associated with the property. The equivalence rule of a property signifies an expected value of the property. It is appreciated that the expected value of the property may correspond to a specific property value or a range of values that the property is expected to have. For instance, the grouping property may be the property of ‘operating system’, and the equivalence rule may signify that the operating system should have a value of ‘Linux 7.9’. Accordingly, all resources in the set of resources 301 that utilize the same operating system i.e., Linux 7.9, are grouped into a resource group e.g., resource group 305A.

In some instances, rather than using a specific value for a property for grouping the set of resources, the equivalence rule may signify a range of values that the property is expected to have. For instance, in one scenario, a set of virtual machines (VMs) may be created using an automated process and those machines may typically never be modified manually. For this reason, a ‘last modified’ property of all the VMs in a group may be within a narrow range. If any machine is altered outside of the regular process, their ‘last modified’ property will be outside of that range. In order to accommodate such scenarios, the baseline generator 112 may be implemented to have a special handling for certain properties, or properties of specific types (such as time). These types may be subject to additional different equivalence relations. For example, the baseline generator 112 may examine each timestamp, identify that all the times are within a 1-minute range and use that as a threshold. In addition, the baseline generator 112 may be configured to increase the range for automatically detected thresholds to allow for some reasonable variance. Another example of a property for which a different equivalence relation may be used is network address. In this case, equivalence relationship may signify that all addresses that are within a same range/subnet can be grouped together. Further, a specific address (e.g., 10.0.0.1) and a network address (e.g., 10.0.0.0/24) may be considered equivalent if the address is in the network range.

In this manner, the resource groups generator 303 included in the baseline generator 112 utilizes the first input criteria 302 (i.e., the set of one or more resource grouping properties, and an associated equivalence rule of each grouping property) to form the one or more resource groups (e.g., 305A, 305B . . . 305K). For example, resource group 1 305A, may be formed based on a first grouping property (and its associated equivalence rule) to include resources R₁, R₇ . . . R_{M-2} that satisfy the equivalence rule associated with the first grouping property. Resource group 2 305B-resource group K 305K are formed by the resource groups generator 303 in a manner similar to that as resource group 1 305A.

Each of the resource groups 305A-305K generated by the resource groups generator 303 is input to the property invariance identifier 307. The property invariance identifier 307 receives a second input criteria 304 including one more properties (and their associated equivalence rules) for identifying invariance in a resource group. The set of one or more properties used for identifying invariance within a resource group are referred to as invariance identifying properties. Specifically, for a given resource group (e.g., resource group 305A), the property invariance identifier 307 determines whether values of an invariance identifying property associated with the plurality of resources (e.g., included in the resource group 305A) satisfy a condition i.e., equivalence rule associated with the invariance identifying property.

In response to successfully identifying the invariance identifying property that is satisfied with respect to a resource group, the property invariance identifier 307 incorporates an invariant (e.g., invariant 309A) into a baseline 311. It is noted that each invariant identified by the property invariance identifier 307 is defined by the grouping property (used to group resources of the resource group by the resource groups generator 303) and the invariance identifying property identified by the property invariance identifier 307. As shown in FIG. 3, invariant 1 309A, is identified by a tuple (i.e., A₁ and B₁), where A₁ corresponds to the property used for grouping resources in the resource group (i.e., resource grouping property) and B₁ corresponds to the invariance identifying property. It is noted that each identified invariant (i.e., 309A to 309P) is incorporated into the baseline 311. Furthermore, it is appreciated that a single resource group (e.g., resource group 305A) may generate one or more invariants that are included in the baseline 311. As will be described later with reference to FIGS. 7A and 7B, the baseline 311 generated (by the baseline generator 112) for a particular environment is used for performing anomaly detection (by the anomaly detector 114 of FIG. 1) in that environment.

FIGS. 4A and 4B depict a flowchart illustrating an example process performed by the baseline generator according to certain embodiments. The processing depicted in FIGS. 4A and 4B may be implemented in software (e.g., code, instructions, program) executed by one or more processing units (e.g., processors, cores) of the respective systems, using hardware, or combinations thereof. The software may be stored on a non-transitory storage medium (e.g., on a memory device). The method presented in FIGS. 4A and 4B and described below is intended to be illustrative and non-limiting. Although FIGS. 4A and 4B depicts the various processing steps occurring in a particular sequence or order, this is not intended to be limiting. In certain alternative embodiments, the processing may be performed in some different order or some steps may also be performed in parallel. In certain embodiments, the processing depicted in FIGS. 4A and 4B may be performed by the baseline generator 112 of FIG. 3.

The process commences in step 401, where the baseline generator receives information identifying an environment that is to be monitored. An example of the environment to be monitored may correspond to the monitored environment 124 or 126 of FIG. 1. Information pertaining to the environment to be monitored may correspond to an identifier associated with the environment or metadata that identifies a particular environment that is to be monitored. The process then moves to step 403, where the the baseline generator identifies a set of resources in the environment to be monitored. For example, the baseline generator may identify the set of resources in the environment as corresponding to the set of resources 301 depicted in FIG. 3.

In step 405, the baseline generator obtains a set of one or more properties that is to be used for grouping resources identified in step 403. For sake of illustration, the set of one or more properties is denoted as set G, which includes properties labeled as gp₁, gp₂ . . . gp_{N}. Note that the properties included in the set G are referred to as grouping properties. In step 407, the baseline generator obtains a set of one or more properties that is to be used for identifying invariance (i.e., invariance identifying properties) in a resource group. For sake of illustration, the set of one or more invariance identifying properties is denoted as set P, which includes properties labeled as ip₁, ip₂ . . . ip_{K}. Thereafter, the process moves to step 409 as depicted in FIG. 4B.

As shown in FIG. 4B, step 409 is an iterative step that is performed for each grouping property in the set G. Specifically, step 409 is performed for a grouping property gpₐ, where a ranges from 1 to N. The iterative process of step 409 includes the steps 411, 413, 414, 415, 417, 419, and 421. In step 411, the equivalence rules for grouping property gpₐ is identified. It is appreciated that a particular grouping property may not have a corresponding equivalence rule. In this case, a default equivalence rule may be applied, where the default equivalence rule corresponds to the grouping property having an “equal to” relationship (as opposed to a range of values). The process then moves to step 413, where for the property (gpₐ) and based on the equivalence rules of the property, the baseline generator determines any resource groups where all resources in the group have equivalent values for property gpₐ i.e., the resources in the resource group satisfy the equivalance rule associated with property gpₐ.

Upon identifying any resource groups that satisfy the equivalence rule associated with property gpₐ, the process moves to step 414. As shown in FIG. 4B, step 414 is a further iterative process that is performed for each resource group identified in step 413. The iterative step 414 includes steps 415, 417, 419, and 421.

Step 415 as shown in FIG. 4B is a further iterative step that iterates over each invariance identifying property (ip_{b}), where the parameter b ranges from 1 to K. Specifically, in the iterative process of step 415, the baseline generator aims to identify any invariance identifying property for the resource group identified in step 414. In step 417, the process identifies equivalence rules for property ip_{b}. It is appreciated that a particular invariance identifying property may not have a corresponding equivalence rule. In this case, a default equivalence rule may be applied, where the default equivalence rule corresponds to the invariance identifying property having an “equal to” relationship.

The process thereafter proceeds to step 419, where, for a resource group determined for grouping property gpₐ, and based on equivalence rule associated with the invariance identifying property ip_{b}, it is determined whether values of property ip_{b} are equivalent across resources included in the resource group. In response to a successful determination in step 419, the process in step 421 marks the tuple (gpₐ, ip_{b}) as an invariant, and futher adds the invariant to a baseline for the monitored environment. It is appreciated that the tuple marked as an invariant i.e., (gpₐ, ip_{b}), includes the equivalence rule associated with the grouping property (gpₐ) as well as the equivalence rule associated with the invariance identifying property (ip_{b}). In this manner, upon completion of the iterative steps of 409, 414, and 415 respectively, the baseline generator generates a baseline for the environment to be monitored. The process thereafter moves to step 423, where the generated baseline is provided to a baseline consumer e.g., system administrator of a cloud environment, for purposes of performing anomaly detection in the environment.

It is appreciated that the above described process performed by the baseline generator may be configured to infer both the grouping properties and invariance identifying properties in an automatic manner. For example, by some embodiments, for the baseline generator to identify security invariants automatically based on grouping properties and invariance identifying properties (and their corresponding equivalence rules), the baseline generator requires to have an ability to identify only those parameters that may have an impact on the security of an environment, and exclude those properties which do not have an effect on the security of the environment. In one embodiment, the baseline generator may be supplied with a pre-defined set of properties that may have a potential impact on the security of the environment and may in turn periodically monitor the properties to identify for equivalences or exclude certain parameters due to their non-equivalence. Furthermore, the process depicted in FIGS. 4A and 4B may allow multiple groupings and invariants to be formed. One may start with a pre-defined set of groupings (e.g., all resources in a compartment, all machines in a subnet) in order to maintain the processing complexity of the baseline generator within acceptable means (e.g., determined by a system administrator).

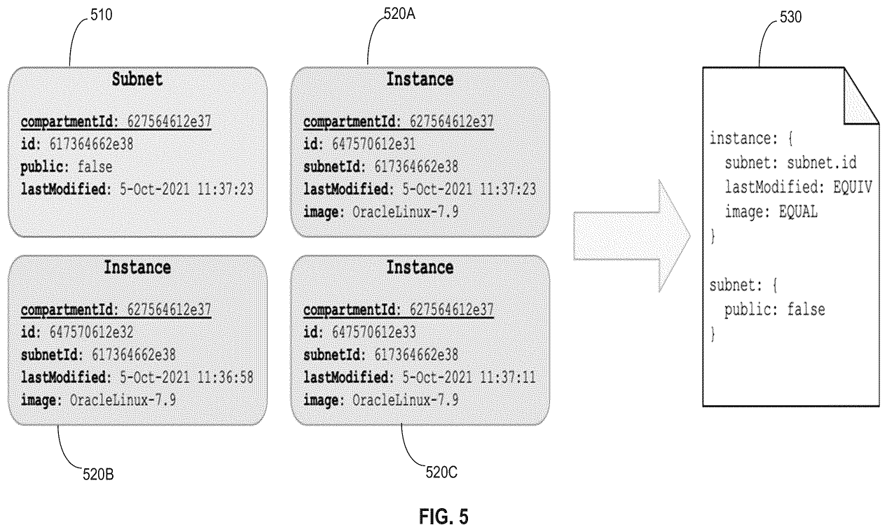

FIG. 5 is a schematic illustrating correlations between properties of cloud resources according to certain embodiments. As shown in FIG. 5, a subnet 510 and instances (e.g., compute instances 520A, 520B, and 520C) that are part of the subnet correspond to resources of a cloud environment. Each resource of the cloud environment has one or more properties. For instance, considering the compute instance 520A, it can be seen that the properties of the compute instance include ‘compartment ID’, ‘ID’, subnet ID′, ‘a last modified’ property, and an ‘image’ property.

As shown in FIG. 5, the ‘compartment ID’ property of the subnet 510, and the compute instances (520A-520C) have identical values. Accordingly, by some embodiments, the subnet and the compute instance resources can be grouped together to form a resource group based on the compartment ID as the grouping property. It is noted that in this case, the equivalence rule of the grouping property (i.e., compartment ID) would correspond to the values of the compartment ID property of the resources in the cloud environment being identical.

In one implementation, the last modified property of the subnets and the compute instances can be used to generate an invariant. Specifically, the last modified property corresponds to a time instant at which the resource of the cloud environment was modified. As seen in FIG. 5, the last modified property of the subnet as well as the compute instances are approximately the same. Thus, in one implementation the last modified property can be used as an invariance identifying property to generate an invariant 530. Note that the equivalence rule of the last modified property in this case may correspond to values of the property (associated with the different resources of the cloud environment) being in a certain time range e.g., 11:37:23±1 minute. In this manner, the invariant 530 may be defined by a tuple of properties i.e., (Compartment ID, Last Modified). The invariant 530 may be incorporated in a baseline which may be used later to perform anomaly detection in the cloud environment.

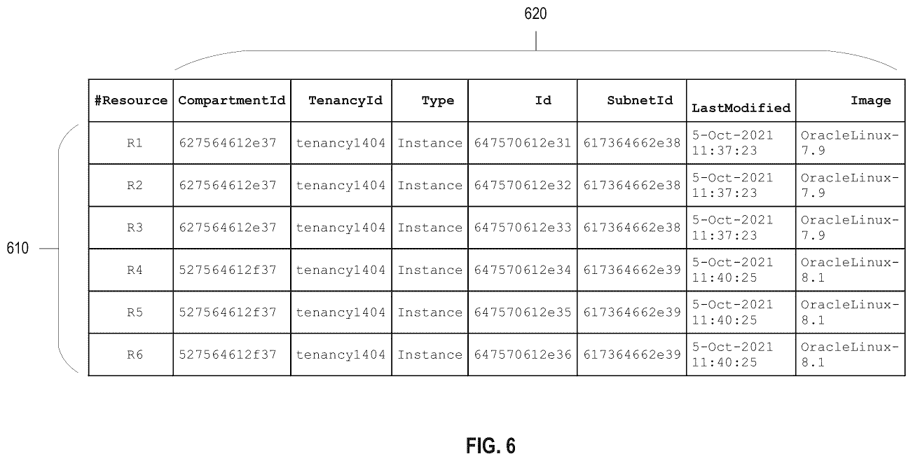

FIG. 6 depicts an exemplary table illustrating resources included in a cloud environment and corresponding properties of the resources according to certain embodiments. As shown in FIG. 6, there are six resources (R1-R6) 610 included in the cloud environment. Each resource includes a plurality of properties 620 including: a compartment ID, a tenancy ID, type, ID, Subnet ID, Last modified property, and an image property. In what follows, there is described an exemplary illustration as to how a baseline generator of an anomaly detection system generates invariants that are to be included in a baseline for anomaly detection purposes.

In one implementation, the baseline generator is configured with two potential properties for partitioning resources into resource groups: {Type, Compartment Id}. In the first step, the baseline generator selects Type as the grouping property. The equivalence rule for the Type property can correspond to values of the Type property of the resources being equal. Based on the Type property being considered for grouping resources, a single resource group is formed i.e., {R1, R2, R3, R4, R5, R6}, as the values of Type property across all resources R1-R6 are equal. Further, consider the case where the baseline generator is configured with two properties {Subnet Id, Image} as being the invariance identifying properties. Note that the Subnet Id property as well as the Image property is not equal across all six resources R1-R6. As such, no invariants are generated based on the Type property, and the baseline generator proceeds to process the next grouping property i.e., Compartment ID.

Considering Compartment ID as the grouping property results in the formation of two resource groups i.e., {{R1, R2, R3}, {R4, R5, R6}}. Further, considering the same invariance identifying properties i.e., {Subnet Id, Image}, it is noted that the Subnet Id property is equal across both groups, as thus a first invariant of (Compartment Id, Subnet Id) is incorporated in a baseline. Further, the Image property is also equal across both groups, and thus a second invariant of (Compartment Id, Image) is incorporated in the baseline. In this manner, the baseline generator generates a baseline for a particular cloud environment, which is later used for detecting anomalies in the environment.

FIGS. 7A and 7B depict a flowchart 700 illustrating an example process of performing anomaly detection, according to certain embodiments. The processing depicted in FIGS. 7A and 7B may be implemented in software (e.g., code, instructions, program) executed by one or more processing units (e.g., processors, cores) of the respective systems, using hardware, or combinations thereof. The software may be stored on a non-transitory storage medium (e.g., on a memory device). The method presented in FIGS. 7A and 7B and described below is intended to be illustrative and non-limiting. Although FIGS. 7A and 7B depicts the various processing steps occurring in a particular sequence or order, this is not intended to be limiting. In certain alternative embodiments, the processing may be performed in some different order or some steps may also be performed in parallel. In certain embodiments, the processing depicted in FIGS. 7A and 7B may be performed by the anomaly detection system 110 of FIG. 1.

The process commences in step 701, where the anomaly detection system detects a trigger signal/event that initiates performing anomaly detection in an environment. By some embodiments, the anomaly detection system may be programmed to periodically perform anomaly detection in the environment. In such a case, a periodic timer signal may correspond to the trigger signal. In step 703, an anomaly detector of the anomaly detection system (e.g., anomaly detector 114 of FIG. 1) retrieves a baseline that is previously generated for detecting anomalies in the environment. It is appreciated that the baseline generator of the anomaly detection system has previously generated and stored the baseline in the anomaly detection system.

The process then moves to step 705, where the anomaly detector identifies one or more invariants in the baseline. Note that each invariant is defined by a resource grouping property that is used for grouping resources, and an invariance identifying property that is used to determine invariance within a group of resources. Upon identifying the one or more invariants, the anomaly detector in step 709 performs anomaly detection of the environment with respect to each of the one or more identified invariants. The details of the anomaly detection performed (i.e., step 709) with respect to each identified invariant of step 705 is described next with reference to FIG. 7B.

As shown in FIG. 7B, the process 750 is an iterative process that is performed with respect to each invariant identified in the baseline. The process commences in step 751, where the anomaly detector identifies a resource group in the environment based on the resource grouping property of an invariant. In step 753, the anomaly detector obtains, with respect to resources included in the resource group, values of the invariance identifying property of the invariant. The process then moves to step 755, where the anomaly detector executes a query to determine whether equivalence relationship (i.e., equivalence rule) of the invariance identifying property of the invariant is exceeded (i.e. violated). In response to an unsuccessful determination in step 755 i.e., the equivalence rule of the invariant is satisfied (thereby indicating no anomaly), the anomaly detection system proceeds to process the next invariant. However, in response to a successful determination in step 755, the anomaly detector in step 757 generates an alert signal indicating the presence of an anomaly in the environment. It is appreciated that such an alert signal may be transmitted to an authorized personnel e.g., administrator of the cloud environment.

### Example Infrastructure as Service Architectures

In certain embodiments, the automated training data segmentation, training and validation of segmented models, evaluation of the segmented models to determine which ones to store, and the deployment and use of the segmented models in a production environment, may be offered as cloud services by a cloud services providers. In certain implementations, the services may be offered under a SaaS model. In some other implementations, the functionality may be offered as a cloud service by an IaaS service provider.

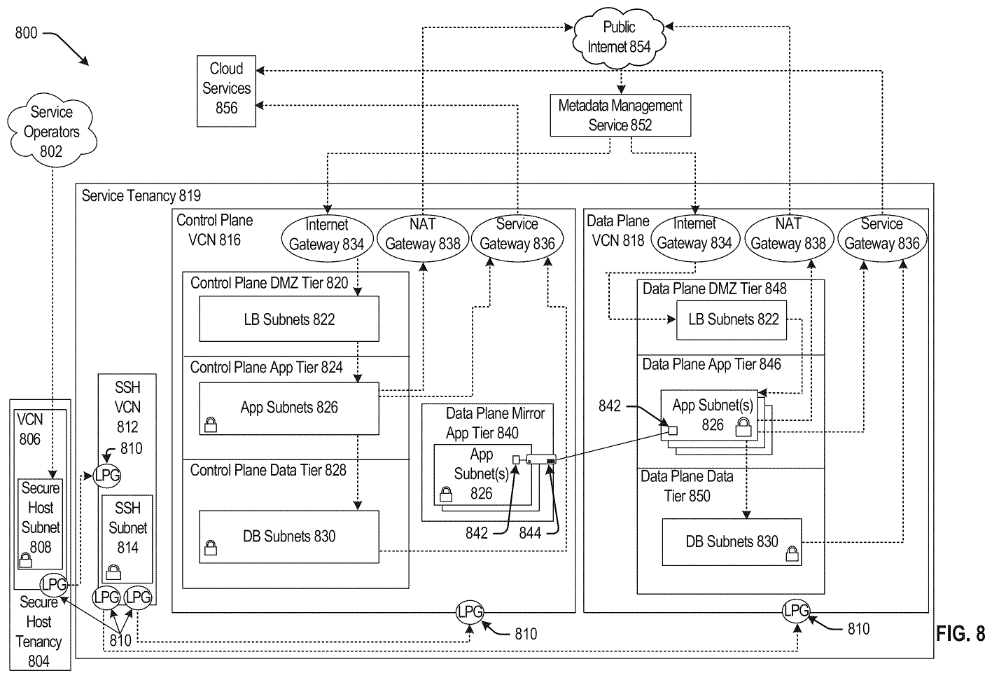

FIG. 8 depicts a system for performing processing related to segmented models in a cloud environment according to various embodiments. As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (e.g., billing, monitoring, logging, security, load balancing and clustering). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different problems for IaaS provisioning. First, there is the initial challenge of provisioning the initial set of infrastructure before anything is running. Second, there is the challenge of evolving the existing infrastructure (e.g., adding new services, changing services, removing services) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more security group rules provisioned to define how the security of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

FIG. 8 is a block diagram 800 illustrating an example pattern of an IaaS architecture, according to at least one embodiment. Service operators 802 can be communicatively coupled to a secure host tenancy 804 that can include a virtual cloud network (VCN) 806 and a secure host subnet 808. In some examples, the service operators 802 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 806 and/or the Internet.

The VCN 806 can include a local peering gateway (LPG) 810 that can be communicatively coupled to a secure shell (SSH) VCN 812 via an LPG 810 contained in the SSH VCN 812. The SSH VCN 812 can include an SSH subnet 814, and the SSH VCN 812 can be communicatively coupled to a control plane VCN 816 via the LPG 810 contained in the control plane VCN 816. Also, the SSH VCN 812 can be communicatively coupled to a data plane VCN 818 via an LPG 810. The control plane VCN 816 and the data plane VCN 818 can be contained in a service tenancy 819 that can be owned and/or operated by the IaaS provider.

The control plane VCN 816 can include a control plane demilitarized zone (DMZ) tier 820 that acts as a perimeter network (e.g., portions of a corporate network between the corporate intranet and external networks). The DMZ-based servers may have restricted responsibilities and help keep security breaches contained. Additionally, the DMZ tier 820 can include one or more load balancer (LB) subnet(s) 822, a control plane app tier 824 that can include app subnet(s) 826, a control plane data tier 828 that can include database (DB) subnet(s) 830 (e.g., frontend DB subnet(s) and/or backend DB subnet(s)). The LB subnet(s) 822 contained in the control plane DMZ tier 820 can be communicatively coupled to the app subnet(s) 826 contained in the control plane app tier 824 and an Internet gateway 834 that can be contained in the control plane VCN 816, and the app subnet(s) 826 can be communicatively coupled to the DB subnet(s) 830 contained in the control plane data tier 828 and a service gateway 836 and a network address translation (NAT) gateway 838. The control plane VCN 816 can include the service gateway 836 and the NAT gateway 838.

The control plane VCN 816 can include a data plane mirror app tier 840 that can include app subnet(s) 826. The app subnet(s) 826 contained in the data plane mirror app tier 840 can include a virtual network interface controller (VNIC) 842 that can execute a compute instance 844. The compute instance 844 can communicatively couple the app subnet(s) 826 of the data plane mirror app tier 840 to app subnet(s) 826 that can be contained in a data plane app tier 846.

The data plane VCN 818 can include the data plane app tier 846, a data plane DMZ tier 848, and a data plane data tier 850. The data plane DMZ tier 848 can include LB subnet(s) 822 that can be communicatively coupled to the app subnet(s) 826 of the data plane app tier 846 and the Internet gateway 834 of the data plane VCN 818. The app subnet(s) 826 can be communicatively coupled to the service gateway 836 of the data plane VCN 818 and the NAT gateway 838 of the data plane VCN 818. The data plane data tier 850 can also include the DB subnet(s) 830 that can be communicatively coupled to the app subnet(s) 826 of the data plane app tier 846.

The Internet gateway 834 of the control plane VCN 816 and of the data plane VCN 818 can be communicatively coupled to a metadata management service 852 that can be communicatively coupled to public Internet 854. Public Internet 854 can be communicatively coupled to the NAT gateway 838 of the control plane VCN 816 and of the data plane VCN 818. The service gateway 836 of the control plane VCN 816 and of the data plane VCN 818 may be communicatively coupled to cloud services 856.

In some examples, the service gateway 836 of the control plane VCN 816 or of the data plane VCN 818 can make application programming interface (API) calls to cloud services 856 without going through public Internet 854. The API calls to cloud services 856 from the service gateway 836 can be one-way: the service gateway 836 can make API calls to cloud services 856, and cloud services 856 can send requested data to the service gateway 836. But, cloud services 856 may not initiate API calls to the service gateway 836.

In some examples, the secure host tenancy 804 can be directly connected to the service tenancy 819, which may be otherwise isolated. The secure host subnet 808 can communicate with the SSH subnet 814 through an LPG 810 that may enable two-way communication over an otherwise isolated system. Connecting the secure host subnet 808 to the SSH subnet 814 may give the secure host subnet 808 access to other entities within the service tenancy 819.

The control plane VCN 816 may allow users of the service tenancy 819 to set up or otherwise provision desired resources. Desired resources provisioned in the control plane VCN 816 may be deployed or otherwise used in the data plane VCN 818. In some examples, the control plane VCN 816 can be isolated from the data plane VCN 818, and the data plane mirror app tier 840 of the control plane VCN 816 can communicate with the data plane app tier 846 of the data plane VCN 818 via VNICs 842 that can be contained in the data plane mirror app tier 840 and the data plane app tier 846.

In some examples, users of the system, or customers, can make requests, for example create, read, update, or delete (CRUD) operations, through public Internet 854 that can communicate the requests to the metadata management service 852. The metadata management service 852 can communicate the request to the control plane VCN 816 through the Internet gateway 834. The request can be received by the LB subnet(s) 822 contained in the control plane DMZ tier 820. The LB subnet(s) 822 may determine that the request is valid, and in response to this determination, the LB subnet(s) 822 can transmit the request to app subnet(s) 826 contained in the control plane app tier 824. If the request is validated and requires a call to public Internet 854, the call to public Internet 854 may be transmitted to the NAT gateway 838 that can make the call to public Internet 854. Memory that may be desired to be stored by the request can be stored in the DB subnet(s) 830.

In some examples, the data plane mirror app tier 840 can facilitate direct communication between the control plane VCN 816 and the data plane VCN 818. For example, changes, updates, or other suitable modifications to configuration may be desired to be applied to the resources contained in the data plane VCN 818. Via a VNIC 842, the control plane VCN 816 can directly communicate with, and can thereby execute the changes, updates, or other suitable modifications to configuration to, resources contained in the data plane VCN 818.

In some embodiments, the control plane VCN 816 and the data plane VCN 818 can be contained in the service tenancy 819. In this case, the user, or the customer, of the system may not own or operate either the control plane VCN 816 or the data plane VCN 818. Instead, the IaaS provider may own or operate the control plane VCN 816 and the data plane VCN 818, both of which may be contained in the service tenancy 819. This embodiment can enable isolation of networks that may prevent users or customers from interacting with other users', or other customers', resources. Also, this embodiment may allow users or customers of the system to store databases privately without needing to rely on public Internet 854, which may not have a desired level of security, for storage.

In other embodiments, the LB subnet(s) 822 contained in the control plane VCN 816 can be configured to receive a signal from the service gateway 836. In this embodiment, the control plane VCN 816 and the data plane VCN 818 may be configured to be called by a customer of the IaaS provider without calling public Internet 854. Customers of the IaaS provider may desire this embodiment since database(s) that the customers use may be controlled by the IaaS provider and may be stored on the service tenancy 819, which may be isolated from public Internet 854.

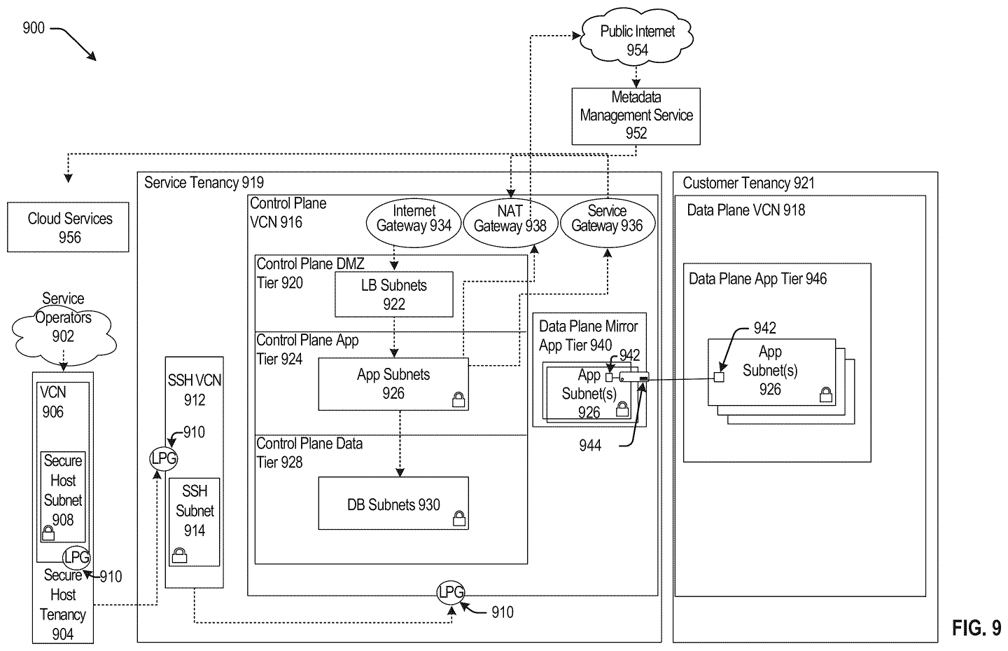

FIG. 9 is a block diagram 900 illustrating another example pattern of an IaaS architecture, according to at least one embodiment. Service operators 902 (e.g. service operators 802 of FIG. 8) can be communicatively coupled to a secure host tenancy 904 (e.g. the secure host tenancy 804 of FIG. 8) that can include a virtual cloud network (VCN) 906 (e.g. the VCN 806 of FIG. 8) and a secure host subnet 908 (e.g. the secure host subnet 808 of FIG. 8). The VCN 906 can include a local peering gateway (LPG) 910 (e.g. the LPG 810 of FIG. 8) that can be communicatively coupled to a secure shell (SSH) VCN 912 (e.g. the SSH VCN 812 of FIG. 8) via an LPG 810 contained in the SSH VCN 912. The SSH VCN 912 can include an SSH subnet 914 (e.g. the SSH subnet 814 of FIG. 8), and the SSH VCN 912 can be communicatively coupled to a control plane VCN 916 (e.g. the control plane VCN 816 of FIG. 8) via an LPG 910 contained in the control plane VCN 916. The control plane VCN 916 can be contained in a service tenancy 919 (e.g. the service tenancy 819 of FIG. 8), and the data plane VCN 918 (e.g. the data plane VCN 818 of FIG. 8) can be contained in a customer tenancy 921 that may be owned or operated by users, or customers, of the system.

The control plane VCN 916 can include a control plane DMZ tier 920 (e.g. the control plane DMZ tier 820 of FIG. 8) that can include LB subnet(s) 922 (e.g. LB subnet(s) 822 of FIG. 8), a control plane app tier 924 (e.g. the control plane app tier 824 of FIG. 8) that can include app subnet(s) 926 (e.g. app subnet(s) 826 of FIG. 8), a control plane data tier 928 (e.g. the control plane data tier 828 of FIG. 8) that can include database (DB) subnet(s) 930 (e.g. similar to DB subnet(s) 830 of FIG. 8). The LB subnet(s) 922 contained in the control plane DMZ tier 920 can be communicatively coupled to the app subnet(s) 926 contained in the control plane app tier 924 and an Internet gateway 934 (e.g. the Internet gateway 834 of FIG. 8) that can be contained in the control plane VCN 916, and the app subnet(s) 926 can be communicatively coupled to the DB subnet(s) 930 contained in the control plane data tier 928 and a service gateway 936 (e.g. the service gateway of FIG. 8) and a network address translation (NAT) gateway 938 (e.g. the NAT gateway 838 of FIG. 8). The control plane VCN 916 can include the service gateway 936 and the NAT gateway 938.

The control plane VCN 916 can include a data plane mirror app tier 940 (e.g. the data plane mirror app tier 840 of FIG. 8) that can include app subnet(s) 926. The app subnet(s) 926 contained in the data plane mirror app tier 940 can include a virtual network interface controller (VNIC) 942 (e.g. the VNIC of 842) that can execute a compute instance 944 (e.g. similar to the compute instance 844 of FIG. 8). The compute instance 944 can facilitate communication between the app subnet(s) 926 of the data plane mirror app tier 940 and the app subnet(s) 926 that can be contained in a data plane app tier 946 (e.g. the data plane app tier 846 of FIG. 8) via the VNIC 942 contained in the data plane mirror app tier 940 and the VNIC 942 contained in the data plane app tier 946.

The Internet gateway 934 contained in the control plane VCN 916 can be communicatively coupled to a metadata management service 952 (e.g. the metadata management service 852 of FIG. 8) that can be communicatively coupled to public Internet 954 (e.g. public Internet 854 of FIG. 8). Public Internet 954 can be communicatively coupled to the NAT gateway 938 contained in the control plane VCN 916. The service gateway 936 contained in the control plane VCN 916 can be communicatively coupled to cloud services 956 (e.g. cloud services 856 of FIG. 8).

In some examples, the data plane VCN 918 can be contained in the customer tenancy 921. In this case, the IaaS provider may provide the control plane VCN 916 for each customer, and the IaaS provider may, for each customer, set up a unique compute instance 944 that is contained in the service tenancy 919. Each compute instance 944 may allow communication between the control plane VCN 916, contained in the service tenancy 919, and the data plane VCN 918 that is contained in the customer tenancy 921. The compute instance 944 may allow resources, that are provisioned in the control plane VCN 916 that is contained in the service tenancy 919, to be deployed or otherwise used in the data plane VCN 918 that is contained in the customer tenancy 921.

In other examples, the customer of the IaaS provider may have databases that live in the customer tenancy 921. In this example, the control plane VCN 916 can include the data plane mirror app tier 940 that can include app subnet(s) 926. The data plane mirror app tier 940 can reside in the data plane VCN 918, but the data plane mirror app tier 940 may not live in the data plane VCN 918. That is, the data plane mirror app tier 940 may have access to the customer tenancy 921, but the data plane mirror app tier 940 may not exist in the data plane VCN 918 or be owned or operated by the customer of the IaaS provider. The data plane mirror app tier 940 may be configured to make calls to the data plane VCN 918, but may not be configured to make calls to any entity contained in the control plane VCN 916. The customer may desire to deploy or otherwise use resources in the data plane VCN 918 that are provisioned in the control plane VCN 916, and the data plane mirror app tier 940 can facilitate the desired deployment, or other usage of resources, of the customer.

In some embodiments, the customer of the IaaS provider can apply filters to the data plane VCN 918. In this embodiment, the customer can determine what the data plane VCN 918 can access, and the customer may restrict access to public Internet 954 from the data plane VCN 918. The IaaS provider may not be able to apply filters or otherwise control access of the data plane VCN 918 to any outside networks or databases. Applying filters and controls by the customer onto the data plane VCN 918, contained in the customer tenancy 921, can help isolate the data plane VCN 918 from other customers and from public Internet 954.

In some embodiments, cloud services 956 can be called by the service gateway 936 to access services that may not exist on public Internet 954, on the control plane VCN 916, or on the data plane VCN 918. The connection between cloud services 956 and the control plane VCN 916 or the data plane VCN 918 may not be live or continuous. Cloud services 956 may exist on a different network owned or operated by the IaaS provider. Cloud services 956 may be configured to receive calls from the service gateway 936 and may be configured to not receive calls from public Internet 954. Some cloud services 956 may be isolated from other cloud services 956, and the control plane VCN 916 may be isolated from cloud services 956 that may not be in the same region as the control plane VCN 916. For example, the control plane VCN 916 may be located in “Region 1,” and cloud service “Deployment 8,” may be located in Region 1 and in “Region 2.” If a call to Deployment 8 is made by the service gateway 936 contained in the control plane VCN 916 located in Region 1, the call may be transmitted to Deployment 8 in Region 1. In this example, the control plane VCN 916, or Deployment 8 in Region 1, may not be communicatively coupled to, or otherwise in communication with, Deployment 8 in Region 2.

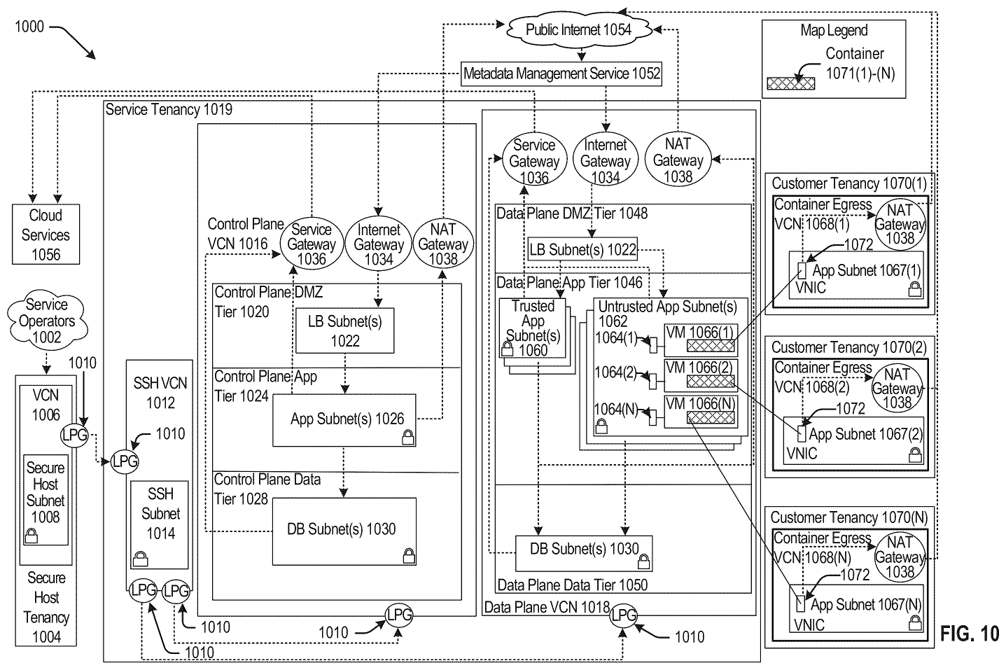

FIG. 10 is a block diagram 1000 illustrating another example pattern of an IaaS architecture, according to at least one embodiment. Service operators 1002 (e.g. service operators 802 of FIG. 8) can be communicatively coupled to a secure host tenancy 1004 (e.g. the secure host tenancy 804 of FIG. 8) that can include a virtual cloud network (VCN) 1006 (e.g. the VCN 806 of FIG. 8) and a secure host subnet 1008 (e.g. the secure host subnet 808 of FIG. 8). The VCN 1006 can include an LPG 1010 (e.g. the LPG 810 of FIG. 8) that can be communicatively coupled to an SSH VCN 1012 (e.g. the SSH VCN 812 of FIG. 8) via an LPG 1010 contained in the SSH VCN 1012. The SSH VCN 1012 can include an SSH subnet 1014 (e.g. the SSH subnet 814 of FIG. 8), and the SSH VCN 1012 can be communicatively coupled to a control plane VCN 1016 (e.g. the control plane VCN 816 of FIG. 8) via an LPG 1010 contained in the control plane VCN 1016 and to a data plane VCN 1018 (e.g. the data plane 818 of FIG. 8) via an LPG 1010 contained in the data plane VCN 1018. The control plane VCN 1016 and the data plane VCN 1018 can be contained in a service tenancy 1019 (e.g. the service tenancy 819 of FIG. 8).

The control plane VCN 1016 can include a control plane DMZ tier 1020 (e.g. the control plane DMZ tier 820 of FIG. 8) that can include load balancer (LB) subnet(s) 1022 (e.g. LB subnet(s) 822 of FIG. 8), a control plane app tier 1024 (e.g. the control plane app tier 824 of FIG. 8) that can include app subnet(s) 1026 (e.g. similar to app subnet(s) 826 of FIG. 8), a control plane data tier 1028 (e.g. the control plane data tier 828 of FIG. 8) that can include DB subnet(s) 1030. The LB subnet(s) 1022 contained in the control plane DMZ tier 1020 can be communicatively coupled to the app subnet(s) 1026 contained in the control plane app tier 1024 and to an Internet gateway 1034 (e.g. the Internet gateway 834 of FIG. 8) that can be contained in the control plane VCN 1016, and the app subnet(s) 1026 can be communicatively coupled to the DB subnet(s) 1030 contained in the control plane data tier 1028 and to a service gateway 1036 (e.g. the service gateway of FIG. 8) and a network address translation (NAT) gateway 1038 (e.g. the NAT gateway 838 of FIG. 8). The control plane VCN 1016 can include the service gateway 1036 and the NAT gateway 1038.

The data plane VCN 1018 can include a data plane app tier 1046 (e.g. the data plane app tier 846 of FIG. 8), a data plane DMZ tier 1048 (e.g. the data plane DMZ tier 848 of FIG. 8), and a data plane data tier 1050 (e.g. the data plane data tier 850 of FIG. 8). The data plane DMZ tier 1048 can include LB subnet(s) 1022 that can be communicatively coupled to trusted app subnet(s) 1060 and untrusted app subnet(s) 1062 of the data plane app tier 1046 and the Internet gateway 1034 contained in the data plane VCN 1018. The trusted app subnet(s) 1060 can be communicatively coupled to the service gateway 1036 contained in the data plane VCN 1018, the NAT gateway 1038 contained in the data plane VCN 1018, and DB subnet(s) 1030 contained in the data plane data tier 1050. The untrusted app subnet(s) 1062 can be communicatively coupled to the service gateway 1036 contained in the data plane VCN 1018 and DB subnet(s) 1030 contained in the data plane data tier 1050. The data plane data tier 1050 can include DB subnet(s) 1030 that can be communicatively coupled to the service gateway 1036 contained in the data plane VCN 1018.

The untrusted app subnet(s) 1062 can include one or more primary VNICs 1064(1)-(N) that can be communicatively coupled to tenant virtual machines (VMs) 1066(1)-(N). Each tenant VM 1066(1)-(N) can be communicatively coupled to a respective app subnet 1067(1)-(N) that can be contained in respective container egress VCNs 1068(1)-(N) that can be contained in respective customer tenancies 1070(1)-(N). Respective secondary VNICs 1072(1)-(N) can facilitate communication between the untrusted app subnet(s) 1062 contained in the data plane VCN 1018 and the app subnet contained in the container egress VCNs 1068(1)-(N). Each container egress VCNs 1068(1)-(N) can include a NAT gateway 1038 that can be communicatively coupled to public Internet 1054 (e.g. public Internet 854 of FIG. 8).

The Internet gateway 1034 contained in the control plane VCN 1016 and contained in the data plane VCN 1018 can be communicatively coupled to a metadata management service 1052 (e.g. the metadata management system 852 of FIG. 8) that can be communicatively coupled to public Internet 1054. Public Internet 1054 can be communicatively coupled to the NAT gateway 1038 contained in the control plane VCN 1016 and contained in the data plane VCN 1018. The service gateway 1036 contained in the control plane VCN 1016 and contained in the data plane VCN 1018 can be communicatively coupled to cloud services 1056.

In some embodiments, the data plane VCN 1018 can be integrated with customer tenancies 1070. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane tier app 1046. Code to run the function may be executed in the VMs 1066(1)-(N), and the code may not be configured to run anywhere else on the data plane VCN 1018. Each VM 1066(1)-(N) may be connected to one customer tenancy 1070. Respective containers 1071(1)-(N) contained in the VMs 1066(1)-(N) may be configured to run the code. In this case, there can be a dual isolation (e.g., the containers 1071(1)-(N) running code, where the containers 1071(1)-(N) may be contained in at least the VM 1066(1)-(N) that are contained in the untrusted app subnet(s) 1062), which may help prevent incorrect or otherwise undesirable code from damaging the network of the IaaS provider or from damaging a network of a different customer. The containers 1071(1)-(N) may be communicatively coupled to the customer tenancy 1070 and may be configured to transmit or receive data from the customer tenancy 1070. The containers 1071(1)-(N) may not be configured to transmit or receive data from any other entity in the data plane VCN 1018. Upon completion of running the code, the IaaS provider may kill or otherwise dispose of the containers 1071(1)-(N).

In some embodiments, the trusted app subnet(s) 1060 may run code that may be owned or operated by the IaaS provider. In this embodiment, the trusted app subnet(s) 1060 may be communicatively coupled to the DB subnet(s) 1030 and be configured to execute CRUD operations in the DB subnet(s) 1030. The untrusted app subnet(s) 1062 may be communicatively coupled to the DB subnet(s) 1030, but in this embodiment, the untrusted app subnet(s) may be configured to execute read operations in the DB subnet(s) 1030. The containers 1071(1)-(N) that can be contained in the VM 1066(1)-(N) of each customer and that may run code from the customer may not be communicatively coupled with the DB subnet(s) 1030.

In other embodiments, the control plane VCN 1016 and the data plane VCN 1018 may not be directly communicatively coupled. In this embodiment, there may be no direct communication between the control plane VCN 1016 and the data plane VCN 1018. However, communication can occur indirectly through at least one method. An LPG 1010 may be established by the IaaS provider that can facilitate communication between the control plane VCN 1016 and the data plane VCN 1018. In another example, the control plane VCN 1016 or the data plane VCN 1018 can make a call to cloud services 1056 via the service gateway 1036. For example, a call to cloud services 1056 from the control plane VCN 1016 can include a request for a service that can communicate with the data plane VCN 1018.

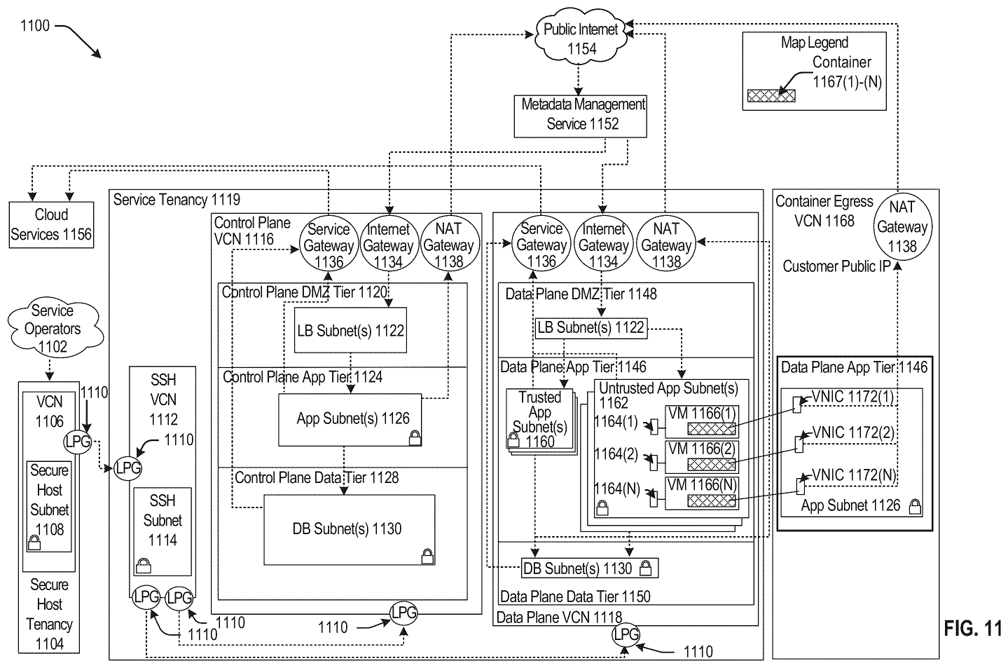

FIG. 11 is a block diagram 1100 illustrating another example pattern of an IaaS architecture, according to at least one embodiment. Service operators 1102 (e.g. service operators 802 of FIG. 8) can be communicatively coupled to a secure host tenancy 1104 (e.g. the secure host tenancy 804 of FIG. 8) that can include a virtual cloud network (VCN) 1106 (e.g. the VCN 806 of FIG. 8) and a secure host subnet 1108 (e.g. the secure host subnet 808 of FIG. 8). The VCN 1106 can include an LPG 1110 (e.g. the LPG 810 of FIG. 8) that can be communicatively coupled to an SSH VCN 1112 (e.g. the SSH VCN 812 of FIG. 8) via an LPG 1110 contained in the SSH VCN 1112. The SSH VCN 1112 can include an SSH subnet 1114 (e.g. the SSH subnet 814 of FIG. 8), and the SSH VCN 1112 can be communicatively coupled to a control plane VCN 1116 (e.g. the control plane VCN 816 of FIG. 8) via an LPG 1110 contained in the control plane VCN 1116 and to a data plane VCN 1118 (e.g. the data plane 818 of FIG. 8) via an LPG 1110 contained in the data plane VCN 1118. The control plane VCN 1116 and the data plane VCN 1118 can be contained in a service tenancy 1119 (e.g. the service tenancy 819 of FIG. 8).

The control plane VCN 1116 can include a control plane DMZ tier 1120 (e.g. the control plane DMZ tier 820 of FIG. 8) that can include LB subnet(s) 1122 (e.g. LB subnet(s) 822 of FIG. 8), a control plane app tier 1124 (e.g. the control plane app tier 824 of FIG. 8) that can include app subnet(s) 1126 (e.g. app subnet(s) 826 of FIG. 8), a control plane data tier 1128 (e.g. the control plane data tier 828 of FIG. 8) that can include DB subnet(s) 1130 (e.g. DB subnet(s) 1030 of FIG. The LB subnet(s) 1122 contained in the control plane DMZ tier 1120 can be communicatively coupled to the app subnet(s) 1126 contained in the control plane app tier 1124 and to an Internet gateway 1134 (e.g. the Internet gateway 834 of FIG. 8) that can be contained in the control plane VCN 1116, and the app subnet(s) 1126 can be communicatively coupled to the DB subnet(s) 1130 contained in the control plane data tier 1128 and to a service gateway 1136 (e.g. the service gateway of FIG. 8) and a network address translation (NAT) gateway 1138 (e.g. the NAT gateway 838 of FIG. 8). The control plane VCN 1116 can include the service gateway 1136 and the NAT gateway 1138.

The data plane VCN 1118 can include a data plane app tier 1146 (e.g. the data plane app tier 846 of FIG. 8), a data plane DMZ tier 1148 (e.g. the data plane DMZ tier 848 of FIG. 8), and a data plane data tier 1150 (e.g. the data plane data tier 850 of FIG. 8). The data plane DMZ tier 1148 can include LB subnet(s) 1122 that can be communicatively coupled to trusted app subnet(s) 1160 (e.g. trusted app subnet(s) 1060 of FIG. 10) and untrusted app subnet(s) 1162 (e.g. untrusted app subnet(s) 1062 of FIG. 10) of the data plane app tier 1146 and the Internet gateway 1134 contained in the data plane VCN 1118. The trusted app subnet(s) 1160 can be communicatively coupled to the service gateway 1136 contained in the data plane VCN 1118, the NAT gateway 1138 contained in the data plane VCN 1118, and DB subnet(s) 1130 contained in the data plane data tier 1150. The untrusted app subnet(s) 1162 can be communicatively coupled to the service gateway 1136 contained in the data plane VCN 1118 and DB subnet(s) 1130 contained in the data plane data tier 1150. The data plane data tier 1150 can include DB subnet(s) 1130 that can be communicatively coupled to the service gateway 1136 contained in the data plane VCN 1118.

The untrusted app subnet(s) 1162 can include primary VNICs 1164(1)-(N) that can be communicatively coupled to tenant virtual machines (VMs) 1166(1)-(N) residing within the untrusted app subnet(s) 1162. Each tenant VM 1166(1)-(N) can run code in a respective container 1167(1)-(N), and be communicatively coupled to an app subnet 1126 that can be contained in a data plane app tier 1146 that can be contained in a container egress VCN 1168. Respective secondary VNICs 1172(1)-(N) can facilitate communication between the untrusted app subnet(s) 1162 contained in the data plane VCN 1118 and the app subnet contained in the container egress VCN 1168. The container egress VCN can include a NAT gateway 1138 that can be communicatively coupled to public Internet 1154 (e.g. public Internet 854 of FIG. 8).

The Internet gateway 1134 contained in the control plane VCN 1116 and contained in the data plane VCN 1118 can be communicatively coupled to a metadata management service 1152 (e.g. the metadata management system 852 of FIG. 8) that can be communicatively coupled to public Internet 1154. Public Internet 1154 can be communicatively coupled to the NAT gateway 1138 contained in the control plane VCN 1116 and contained in the data plane VCN 1118. The service gateway 1136 contained in the control plane VCN 1116 and contained in the data plane VCN 1118 can be communicatively coupled to cloud services 1156.

In some examples, the pattern illustrated by the architecture of block diagram 1100 of FIG. 11 may be considered an exception to the pattern illustrated by the architecture of block diagram 1000 of FIG. 10 and may be desirable for a customer of the IaaS provider if the IaaS provider cannot directly communicate with the customer (e.g., a disconnected region). The respective containers 1167(1)-(N) that are contained in the VMs 1166(1)-(N) for each customer can be accessed in real-time by the customer. The containers 1167(1)-(N) may be configured to make calls to respective secondary VNICs 1172(1)-(N) contained in app subnet(s) 1126 of the data plane app tier 1146 that can be contained in the container egress VCN 1168. The secondary VNICs 1172(1)-(N) can transmit the calls to the NAT gateway 1138 that may transmit the calls to public Internet 1154. In this example, the containers 1167(1)-(N) that can be accessed in real-time by the customer can be isolated from the control plane VCN 1116 and can be isolated from other entities contained in the data plane VCN 1118. The containers 1167(1)-(N) may also be isolated from resources from other customers.

In other examples, the customer can use the containers 1167(1)-(N) to call cloud services 1156. In this example, the customer may run code in the containers 1167(1)-(N) that requests a service from cloud services 1156. The containers 1167(1)-(N) can transmit this request to the secondary VNICs 1172(1)-(N) that can transmit the request to the NAT gateway that can transmit the request to public Internet 1154. Public Internet 1154 can transmit the request to LB subnet(s) 1122 contained in the control plane VCN 1116 via the Internet gateway 1134. In response to determining the request is valid, the LB subnet(s) can transmit the request to app subnet(s) 1126 that can transmit the request to cloud services 1156 via the service gateway 1136.

It should be appreciated that IaaS architectures 800, 900, 1000, 1100 depicted in the figures may have other components than those depicted. Further, the embodiments shown in the figures are only some examples of a cloud infrastructure system that may incorporate certain embodiments. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

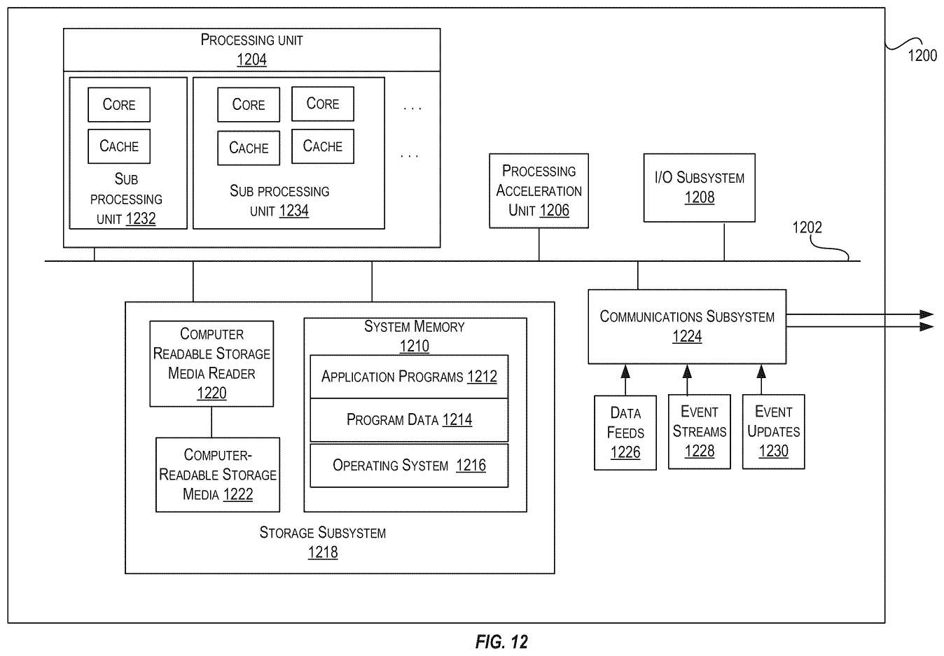

FIG. 12 illustrates an example computer system 1200, that may be used to implement various embodiments. The system 1200 may be used to implement any of the computer systems described above. As shown in the figure, computer system 1200 includes a processing unit 1204 that communicates with a number of peripheral subsystems via a bus subsystem 1202. These peripheral subsystems may include a processing acceleration unit 1206, an I/O subsystem 1208, a storage subsystem 1218 and a communications subsystem 1224. Storage subsystem 1218 includes tangible computer-readable storage media 1222 and a system memory 1210.

Bus subsystem 1202 provides a mechanism for letting the various components and subsystems of computer system 1200 communicate with each other as intended. Although bus subsystem 1202 is shown schematically as a single bus, alternative embodiments of the bus subsystem may utilize multiple buses. Bus subsystem 1202 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1204, which can be implemented as one or more integrated circuits (e.g., a conventional microprocessor or microcontroller), controls the operation of computer system 1200. One or more processors may be included in processing unit 1204. These processors may include single core or multicore processors. In certain embodiments, processing unit 1204 may be implemented as one or more independent processing units 1232 and/or 1234 with single or multicore processors included in each processing unit. In other embodiments, processing unit 1204 may also be implemented as a quad-core processing unit formed by integrating two dual-core processors into a single chip.

In various embodiments, processing unit 1204 can execute a variety of programs in response to program code and can maintain multiple concurrently executing programs or processes. At any given time, some or all of the program code to be executed can be resident in processor(s) 1204 and/or in storage subsystem 1218. Through suitable programming, processor(s) 1204 can provide various functionalities described above. Computer system 1200 may additionally include a processing acceleration unit 1206, which can include a digital signal processor (DSP), a special-purpose processor, and/or the like.

I/O subsystem 1208 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1200 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1200 may comprise a storage subsystem 1218 that comprises software elements, shown as being currently located within a system memory 1210. System memory 1210 may store program instructions that are loadable and executable on processing unit 1204, as well as data generated during the execution of these programs.

Depending on the configuration and type of computer system 1200, system memory 1210 may be volatile (such as random access memory (RAM)) and/or non-volatile (such as read-only memory (ROM), flash memory, etc.) The RAM typically contains data and/or program modules that are immediately accessible to and/or presently being operated and executed by processing unit 1204. In some implementations, system memory 1210 may include multiple different types of memory, such as static random access memory (SRAM) or dynamic random access memory (DRAM). In some implementations, a basic input/output system (BIOS), containing the basic routines that help to transfer information between elements within computer system 1200, such as during start-up, may typically be stored in the ROM. By way of example, and not limitation, system memory 1210 also illustrates application programs 1212, which may include client applications, Web browsers, mid-tier applications, relational database management systems (RDBMS), etc., program data 1214, and an operating system 1216. By way of example, operating system 1216 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® 12 OS, and Palm® OS operating systems.

Storage subsystem 1218 may also provide a tangible computer-readable storage medium for storing the basic programming and data constructs that provide the functionality of some embodiments. Software (programs, code modules, instructions) that when executed by a processor provide the functionality described above may be stored in storage subsystem 1218. These software modules or instructions may be executed by processing unit 1204. Storage subsystem 1218 may also provide a repository for storing data used in accordance with the present disclosure.

Storage subsystem 1200 may also include a computer-readable storage media reader 1220 that can further be connected to computer-readable storage media 1222. Together and, optionally, in combination with system memory 1210, computer-readable storage media 1222 may comprehensively represent remote, local, fixed, and/or removable storage devices plus storage media for temporarily and/or more permanently containing, storing, transmitting, and retrieving computer-readable information.

Computer-readable storage media 1222 containing code, or portions of code, can also include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computing system 1200.

By way of example, computer-readable storage media 1222 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1222 may include, but is not limited to, Zip® drives, flash memory cards, universal serial bus (USB) flash drives, secure digital (SD) cards, DVD disks, digital video tape, and the like. Computer-readable storage media 1222 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1200.

Communications subsystem 1224 provides an interface to other computer systems and networks. Communications subsystem 1224 serves as an interface for receiving data from and transmitting data to other systems from computer system 1200. For example, communications subsystem 1224 may enable computer system 1200 to connect to one or more devices via the Internet. In some embodiments communications subsystem 1224 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communications subsystem 1224 can provide wired network connectivity (e.g., Ethernet) in addition to or instead of a wireless interface.

In some embodiments, communications subsystem 1224 may also receive input communication in the form of structured and/or unstructured data feeds 1226, event streams 1228, event updates 1230, and the like on behalf of one or more users who may use computer system 1200.

By way of example, communications subsystem 1224 may be configured to receive data feeds 1226 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1224 may also be configured to receive data in the form of continuous data streams, which may include event streams 1228 of real-time events and/or event updates 1230, that may be continuous or unbounded in nature with no explicit end. Examples of applications that generate continuous data may include, for example, sensor data applications, financial tickers, network performance measuring tools (e.g. network monitoring and traffic management applications), clickstream analysis tools, automobile traffic monitoring, and the like.

Communications subsystem 1224 may also be configured to output the structured and/or unstructured data feeds 1226, event streams 1228, event updates 1230, and the like to one or more databases that may be in communication with one or more streaming data source computers coupled to computer system 1200.

Computer system 1200 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1200 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or modules are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A method comprising:
generating a resource group including a plurality of resources of a monitored environment based on a grouping property, wherein values of the grouping property associated with the plurality of resources satisfy a first condition;
selecting a first invariance identifying property from a set of invariance identifying properties;
determining whether values of the first invariance identifying property associated with the plurality of resources satisfy a second condition;
responsive to a successful determination, incorporating a first invariant in a baseline, wherein the first invariant is defined by the grouping property and the first invariance identifying property; and
using the baseline for performing anomaly detection of the monitored environment.

2. The method of claim 1, further comprising:
identifying a first equivalence rule associated with the grouping property and a second equivalence rule associated with the first invariance identifying property.

3. The method of claim 2, wherein the first condition corresponds to the values of the grouping property associated with the plurality of resources satisfying the first equivalence rule, the first equivalence rule corresponding to the values of the grouping property associated with the plurality of resources being in a first predetermined range of values associated with the grouping property.

4. The method of claim 2, wherein the first equivalence rule corresponds to the values of the grouping property associated with the plurality of resources being identical.

5. The method of claim 2, wherein the second condition corresponds to values of the first invariance identifying property associated with the plurality of resources satisfying the second equivalence rule, the second equivalence rule corresponding to the values of the first invariance identifying property associated with the plurality of resources being in a second predetermined range of values associated with the first invariance identifying property.

6. The method of claim 2, wherein the second equivalence rule corresponds to the values of the first invariance identifying property associated with the plurality of resources being identical.

7. The method of claim 2, wherein the first invariant is further defined by the first equivalence rule and the second equivalence rule.

8. The method of claim 1, further comprising:
selecting a second invariance identifying property from the set of invariance identifying properties;
determining whether values of the second invariance identifying property associated with the plurality of resources satisfy a third condition; and
responsive to a successful determination, incorporating a second invariant in the baseline, wherein the second invariant is defined by the grouping property and the second invariance identifying property.

9. The method of claim 8, further comprising:
performing anomaly detection of the monitored environment using the baseline including the first invariant and the second invariant.

10. The method of claim 1, further comprising:
detecting a trigger signal to initiate anomaly detection of the monitored environment;
performing anomaly detection of the monitored environment in response to detecting the trigger signal; and
generating an alert signal responsive to detecting an anomaly in the monitored environment.

11. A computing device comprising:
a processor; and
a memory including instructions that, when executed with the processor, cause the computing device to, at least:
generate a resource group including a plurality of resources of a monitored environment based on a grouping property, wherein values of the grouping property associated with the plurality of resources satisfy a first condition;
select a first invariance identifying property from a set of invariance identifying properties;
determine whether values of the first invariance identifying property associated with the plurality of resources satisfy a second condition;
responsive to a successful determination, incorporate a first invariant in a baseline, wherein the first invariant is defined by the grouping property and the first invariance identifying property; and
use the baseline for performing anomaly detection of the monitored environment.

12. The computing device of claim 11, wherein the processor is further configured to identify a first equivalence rule associated with the grouping property and a second equivalence rule associated with the first invariance identifying property.

13. The computing device of claim 12, wherein the first condition corresponds to the values of the grouping property associated with the plurality of resources satisfying the first equivalence rule, the first equivalence rule corresponding to the values of the grouping property associated with the plurality of resources being in a first predetermined range of values associated with the grouping property.

14. The computing device of claim 12, wherein the first equivalence rule corresponds to the values of the grouping property associated with the plurality of resources being identical.

15. The computing device of claim 12, wherein the second condition corresponds to values of the first invariance identifying property associated with the plurality of resources satisfying the second equivalence rule, the second equivalence rule corresponding to the values of the first invariance identifying property associated with the plurality of resources being in a second predetermined range of values associated with the first invariance identifying property.

16. The computing device of claim 12, wherein the second equivalence rule corresponds to the values of the first invariance identifying property associated with the plurality of resources being identical.

17. The computing device of claim 11, wherein the processor is further configured to:
select a second invariance identifying property from the set of invariance identifying properties;
determine whether values of the second invariance identifying property associated with the plurality of resources satisfy a third condition;
responsive to a successful determination, incorporate a second invariant in the baseline, wherein the second invariant is defined by the grouping property and the second invariance identifying property; and
perform anomaly detection of the monitored environment using the baseline including the first invariant and the second invariant.

18. The computing device of claim 11, wherein the processor is further configured to:
detect a trigger signal to initiate anomaly detection of the monitored environment;
perform anomaly detection of the monitored environment in response to detecting the trigger signal; and
generate an alert signal responsive to detecting an anomaly in the monitored environment.

19. A non-transitory computer readable medium storing specific computer-executable instructions that, when executed by a processor, cause a computer system to perform operations comprising:
identifying a set of resources in an environment to be monitored;
generating one or more resource groups, each resource group including a plurality of resources and being generated based on a grouping property, wherein values of the grouping property associated with the plurality of resources included in the resource group satisfy a first condition;
identifying, for each of the one or more resource groups, an invariance identifying property;
determining, for each of the one or more resource groups, whether values of the invariance identifying property associated with the plurality of resources included in the resource group satisfy a second condition;
responsive to a successful determination, incorporating an invariant in a baseline, wherein the invariant is defined by the grouping property and the invariance identifying property; and
using the baseline for performing anomaly detection of the environment to be monitored.

20. The non-transitory computer readable medium storing specific computer-executable instructions of claim 19, further comprising:
identifying a first equivalence rule associated with the grouping property and a second equivalence rule associated with the invariance identifying property, wherein the first condition corresponds to the values of the grouping property associated with the plurality of resources satisfying the first equivalence rule, the first equivalence rule corresponding to the values of the grouping property associated with the plurality of resources being in a first predetermined range of values associated with the grouping property.
